(19) United States
(12) Patent Application Publication
(10) Pub. No.: US 2003/0212596 A1
(43) Pub. Date: Nov. 13, 2003

(54) Computer network for distribution of retail service/product promotions

(76) Inventors: William R. DiPaolo, Carlsbad, CA (US); Robert A. Brindle, Cordova, TN (US)

Correspondence Address: Steven W. Webb, Law Offices of Steven W. Webb, 655 Second Street, Encinitas, CA, 92024, US

(21) Appl. No.: 10/143,684

(22) Filed: May 13, 2002

(51) Int. Cl. G06F 17/60

(52) U.S. Cl. 705/14; 705/26

(57) ABSTRACT

What is presented is an improved computer-based product promotion reward distribution system using centralized data storage servers, marketing organization computers, and consumer home computers. Consumer demographic data will be collected anonymously and consumer privacy will be maintained. Consumers will inform merchandising organizations which items they would be willing to receive coupons for, maximizing coupon distribution efficiency.

### BACKGROUND OF THE INVENTION

This invention relates to consumer products merchandising systems and particularly to coupon distribution in directed, narrowly defined campaigns. This invention also relates to consumer privacy protection for distributed computer networks. Merchandisers regularly issue billions of coupons, rebates and store sale notifications, cumulatively called retail product/service promotions (RSPPs) each year in newspapers, direct mail distributions, e-mail and other means. These RSPPs are most effective when they are distributed to a large number of consumers in a company's respective target market. Experience has shown that free-standing newspaper inserts, direct mail, e-mail and other RSPP mass distribution campaigns fail to achieve the desired market penetration. This results in the RSPP reaching only a tiny fraction of the market and consumer redemption rates of approximately 1%.

A more focused RSPP distribution approach via the Internet (specifically targeted e-mail) has been created in recent years, using the connectedness that most consumers enjoy via their home computer systems. However, this is only an alternative (and more cost effective) means for delivering targeted mailings, which has been employed by catalog retailers for decades. Mass distribution of RSPP, whether by newspaper, regular mail or e-mail will always be delivered whether the consumer desires to receive the RSPP or not. As a result, a consumer must manually filter through an increasing profusion of undesired RSPPs if he or she hopes to find an RSPP of value. This manual filtering process must be repeated with every RSPP delivered, no matter the distribution channel. It is now possible to create an alternative RSPP distribution channel that matches consumer purchase intention to RSPP using the Internet and distributed computing power.

This invention is a system of distributed computers with accompanying software that implements a unique approach to solving the problem of matching consumer purchase intention to distributed RSPP while automatically filtering out RSPP that do not provide immediate value. This results in more RSPP being redeemed benefiting both consumers and merchandisers.

The issue of consumer privacy is also addressed by this invention since it creates a communication channel designed specifically for delivery of RSPP. No personal communication information (such as name, mailing address, e-mail address or phone number) need be revealed by the consumer to participate on said channel. This invention provides the maximum available consumer privacy consonant with the increased flexibility and efficiency of RSPP distribution.

### BRIEF SUMMARY OF THE INVENTION

The invention consists of two computer based software programs called Scout and Distributor. Scout software resides and runs on the individual consumer's home computers and is used to provide anonymous demographic and purchase intention data to RSPP distributors. Scout users select product/service categories as well as (if desired) product/service brands for which they desire to receive RSPP. Scout filters out all RSPP that do not specifically match the selected product/service categories. At the moment the consumer wants to shop, he views the accumulated RSPP (by category) and with one mouse click prints the list of items and all associated RSPP on his printer.

Distributor is used by RSPP distributors to create, launch and measure the progress of RSPP campaigns. Distributor collects data on every RSPP printed and paints a real-time picture of the campaigns effectiveness via the Vaulte Systems owned server computers. All Scout data is anonymous to protect consumer privacy, yet business can communicate and target said customers specifically if they have identified the company's product or service as one that is desired. This is accomplished via Vaulte's proprietary communication channel consisting of the Scout-Vaulte System's Web Server-Distributor network (Scout Network).

Distributor users can identify by category households considered loyal, competitive or open to any RSPP in the product/service category. Businesses can instantly publish RSPP in the forms of coupons, rebates or store sale notifications and shortly see real-time acceptance rates. This feedback permits the merchant to adjust the coupon campaign to more effective meet consumer expectations.

Some of the invention's advantages include limiting the risk of coupon campaigns. To reach the highest number of interested consumers merchandisers regularly use newspapers, magazines, direct mail or e-mail to deliver millions of RSPP in a single campaign. Merchants must endure lengthy campaign lead times to use said distribution channels and face significant risk in that millions of RSPP could be redeemed or very few. The Scout Network invention gives merchants the power in instantly launch and measure campaign effectiveness while simultaneously limiting this risk strictly.

### SUMMARY OF THE INVENTION

It is an object of the present invention to provide near-real-time RSPP distribution and measurement using the Internet to communicate between consumer product and service providers and consumers ready to purchase in their respective categories, and even their respective brand.

It is a further object of the present invention to allow consumers to specify the products and services for which they would be willing to accept RSPP.

It is a further object of the present invention to allow consumers to specify their product/service purchase intentions and make them available to marketing organizations while maintaining an anonymous communication and marketing channel with said organizations.

It is a further object of the present invention to manage the information collected from users in such a manner that marketing organizations can benefit from specific consumer brand and product choices by automatically distributing RSPP to specific, yet anonymous consumers.

It is a further object of the present invention to provide software to the consumer to be run on the consumer's privately-owned home computer equipment that performs product and service category and brand purchase intention specification.

It is a further object of the present invention to enable said home computer software to support consumer product and service choice data entry within a point and click forms-driven environment.

It is a further object of the present invention to allow said home computer software to collect, organize and print RSPP for all specified product and service brands and/or categories.

It is a further object of the present invention to allow users to click on any RSPP to see more information about the product/service represented—defined as a Brand Badge.

It is a further object of the present invention to allow said home computer software to automatically filter out any RSPP for product and service categories and/or brands that have not been specifically identified by the consumer.

It is a further object of the present invention to provide software businesses that enables them to design RSPP that meet marketing goals based on data from consumers using the home computer software.

It is a further object of the present invention that the foregoing features be implemented over the Internet and that the communication processes involved in moving data from home computers to marketers be done in the background, invisibly to the consumer.

### BRIEF DESCRIPTION OF THE DRAWINGS

The construction and operation of the invention can be readily appreciated from inspection of the drawings that accompany this application, combined with the detailed specification to follow.

FIGS 1A and 1B are a flow diagram showing basic Scout/Server synchronization operation.

FIG. 2 is a flow diagram for the Scout RSPP browsing process.

FIGS. 3A and 3B are a flow diagram for the Distributor process.

FIG. 4 is a flow diagram of the Scout “other offers” process.

FIGS. 5A and 5B are a flow diagram of the Distributor campaign process.

FIGS. 6A, 6B, and 6C are a flow diagram of the Scout user shopping list process.

FIGS. 7A, 7B, and 7C are a flow diagram of the Distributor Campaign risk/liability management process.

FIG. 8 is a flow diagram of the Lifegear configuration process.

FIGS. 9A and 9B are a flow diagram for the RSPP viewing and selection process.

FIG. 10 is a flow diagram for the Distributor Campaign distribution process.

### DETAILED DESCRIPTION OF THE INVENTION

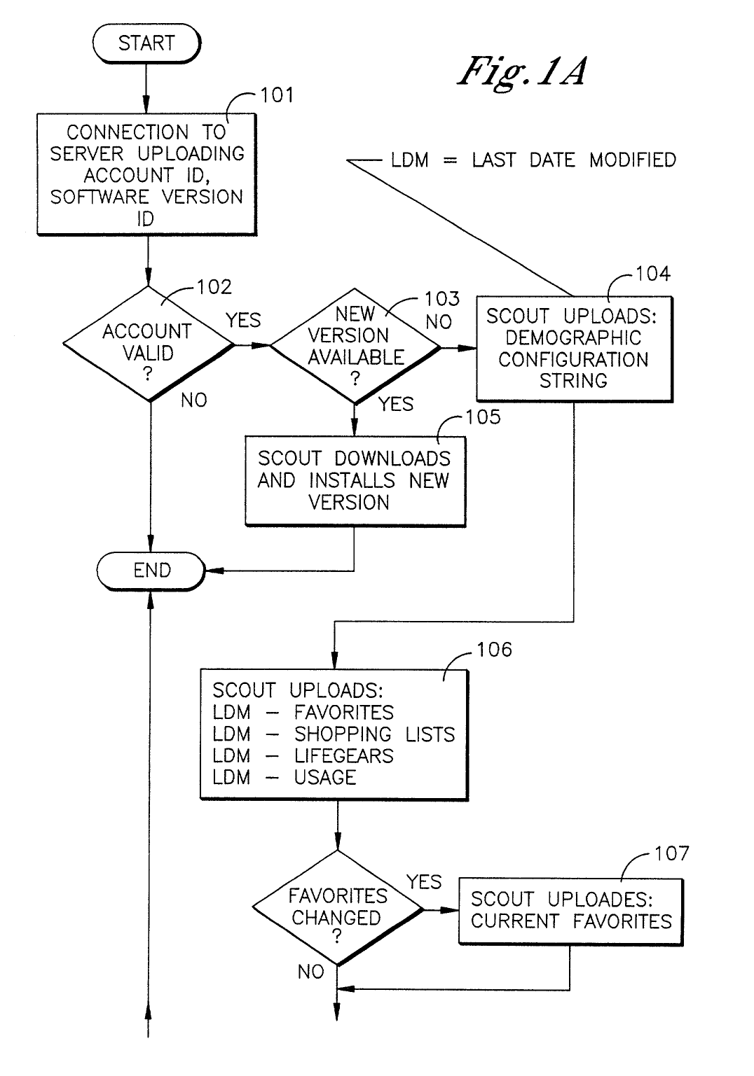

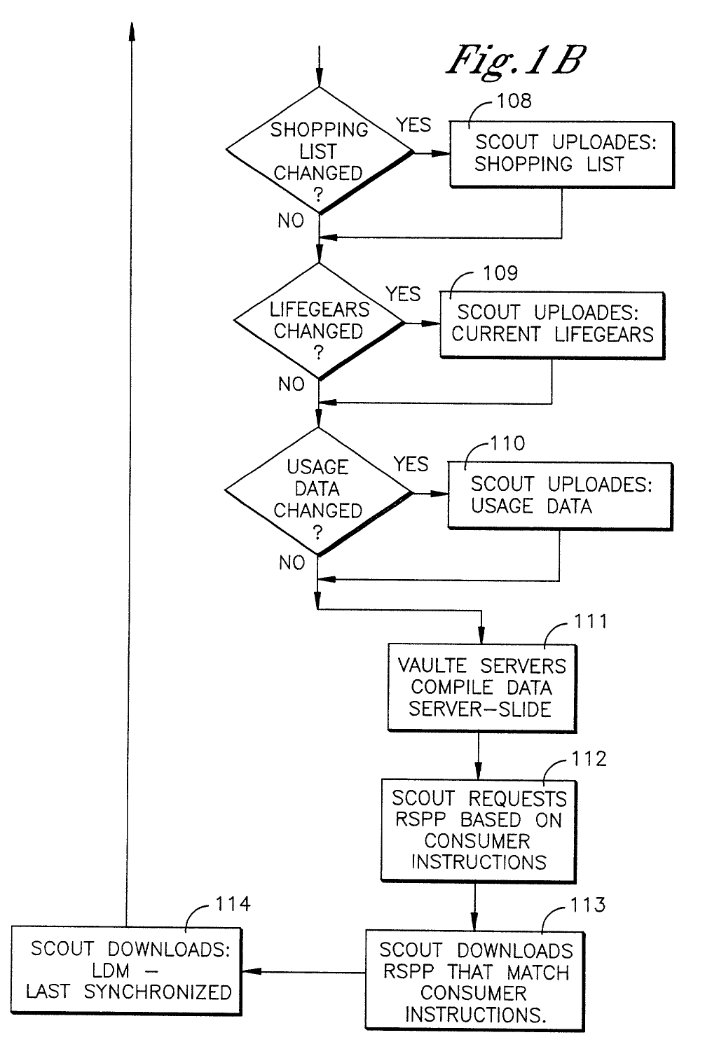

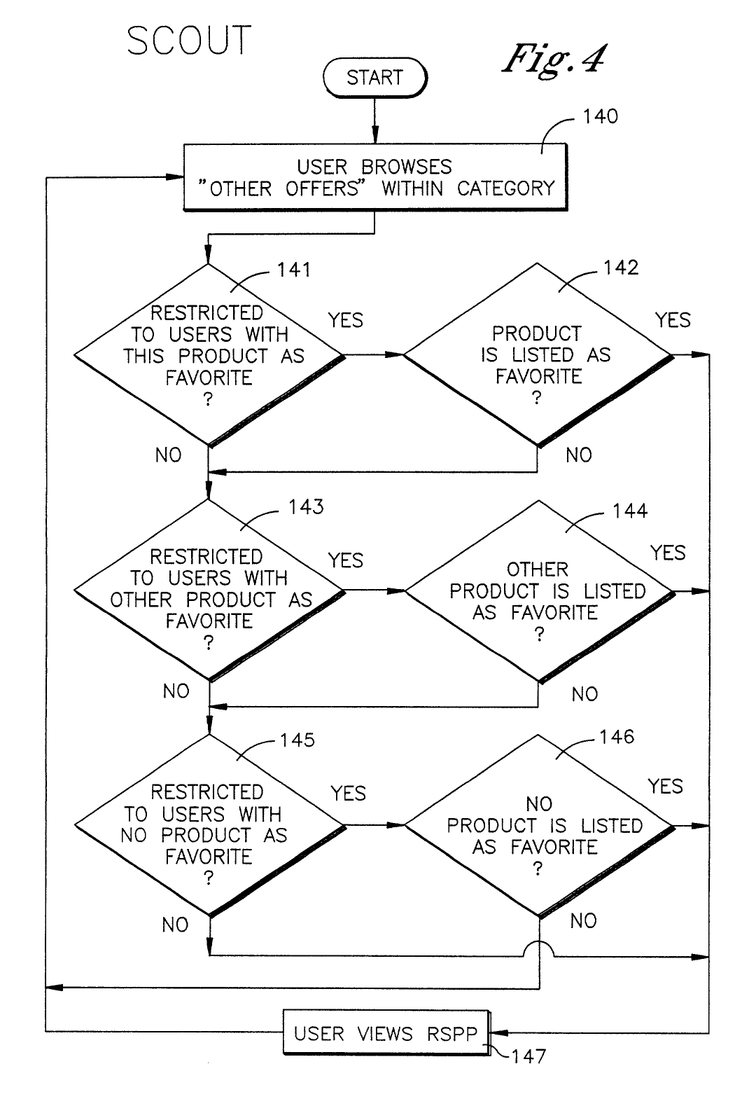

The invention is best understood by referring to the preferred embodiment illustrated in the drawings in FIGS. 1 through 8. The preferred embodiment is comprised of the Distributor software system to be used by corporate marketing departments to design, launch and measure RSPP campaigns and the Scout software system, to be used by consumers in their home computer environments.

Distributor—This software is comprised of the Product Manager, the Promotion Manager and the Campaign Manager. They are designed to be used sequentially by product and service marketers to prepare, launch and measure RSPP campaigns.

Product Manger—This software wizard creates a LifeGear association when that businesses account is activated. All RSPP from that business can only be viewed under that specific LifeGear by consumers using Scout software. Further, the product or service from that business can be attached to a specific category under the relevant LifeGear. Marketers may insert an image to represent said product or service that will appear should the consumer print the RSPP.

Marketers have the option of associating a Brand Badge with each product or service which will be viewed by the consumer when he desires more information on the product/service promoted by the RSPP. If the marketer distributes RSPP in the Pantry (supermarket items) category it has the option of designating the product as “New” to have it featured as such in the Scout Pantry on the consumer's home computer.

Promotion Manager—There are three distinct promotion types with the Scout Network—coupons, rebates and Store Sale Notifications, collectively called Retail Service and Product Promotions (RSPP). Coupon promotions are certificates or coupons that save the consumer money at the time of purchase provided users must meet some purchase conditions. The invention supports six types of coupon promotion in its current embodiment: 1) Save # dollars, 2) save # percentage, 3) buy # of a product get # of same or different product free, 4) buy # of a product get # of same or different product at a certain price, 5) buy # of a product get # of same or different product at # percent off, 6) get item for free.

Users select the RSPP type by clicking on a corresponding template. Templates define the RSPP style and capture the dollar value (reward value) fore each RSPP. Scout captures this value each time an RSPP is printed on the consumer's local printer. As a result individual Scout users can see a real-time tally of how much money they have saved with Scout RSPPs as individuals and as a household.

The template also captures text and numeric data that defines consumer and retailer instructions (said text being able to be saved as default text), Universal Product Code (UPC ) values and internal product/service identification values.

RSPP images (as seen when printed by Scout users) can be supplied by pasting them into the Promotion Manger—or they can be generated by Scout based on the assigned template for the RSPP.

Rebate promotions entitle consumer to a specific financial reward after time of purchase. Consumer submits the rebate to manufacturer along with proof of purchase and receives a check for the stated promotion amount. Alternative embodiments of this invention allow marketer to customize rebate rewards to the consumer, but the preferred embodiment simply passes a single image to the Scout software.

The Promotion Manger allows RSPP defaults (set up by the Distributor user in advance), which can be overridden by the marketer at the time of designing a RSPP. Promotion manager allows entry of a default soft expiration date value for the RSPP. The soft expiration date value defines an expiration date based on the day the Scout user prints the RSPP. For example, if the default soft expiration date is defined as “2”, the RSPP will print an expiration date exactly two days from the date the RSPP was printed. This encourages the Scout user to redeem the RSPP immediately.

Campaign Manager—Campaign Manager allows the marketer the ability to launch and control RSPP distribution where it makes the most sense and limits exposure and liability for the marketer during the campaign. Using Distributor software, campaigns can be limited geographically or demographically. Additionally campaigns can be limited to individuals who enter specific sequences of text and/or numbers. These rewards will be “hidden” from Scout unless the consumer invokes the hidden reward by entering the predefined text and/or numeric sequence in Scout's Hidden Reward field on Scout's main screen. Only then can the hidden RSPP be printed.

In the preferred embodiment the demographic limiters include the Scout users' brand loyalty status, measured by whether the consumer has selected a specific brand as a “favorite” in a product or service category. If so selected, the consumer is designated a “loyal user” of that brand and can be targeted as such. If the consumer has selected a different company's brand as a favorite while simultaneously not selecting the company's brand the consumer is designated a “competitive user” and can be targeted as such. If the consumer has selected every brand as a favorite or selected no specific brand as a favorite, the consumer is designated an “open user” and can be targeted as such.

Geographic limiters include sending RSPP to specific states, cities and/or zip codes. Scout users, upon registration, enter the household zip code and can there for be targeted by such.

Campaign manager is used to assign a “hard expiration date” to any RSPP by selecting a specific date on a calendar. This date is only printed on the RSPP if the soft expiration date would yield a date beyond the defined hard expiration date. The hard expiration date also defines when the RSPP will be removed from the Scout Network.

The “Kill At Number” (KAN) is a numeric value that further protects a marketer's liability. The KAN is continually compared against the number of RSPPs that have been printed by any Scout user. Once the KAN is reached, the campaign is removed from the Scout Network even if the hard expiration date has not been reached. A marketer can manually invoke the KAN at any time by clicking a button that changes the KAN to the number of RSPPs currently printed, effectively canceling the RSPP immediately.

Distributor also reports in two modes: on-line indicators and off-line reports. On-line indicators are a real-time cross tabulation display to manage active RSPP campaigns and contain (in the preferred embodiment) fields such as 1) absolute number of consumers in the target group, 2) potential dollar liability, 3) current liability, 4) current number of RSPPs printed, and 5) remaining liability of the RSPP. Distributor also provides reports that reveal how a company's specific product or service is perceived by the target audience. These reports provide data that answer the following questions for marketers:

1) In my product's category, what is my market share based on the consumers that have selected it as a favorite?

2) What does my customer look like for each of my specific products?

3) What is the most/least effective RSPPs I have run for a specific product in terms of average number printed per day.

4) Which products produce the most printed RSPPs?

5) What is the most successful category in my LifeGear?

6) Which is the most successful campaign currently active/ever launched?

Distributor also produces a number of on the fly graphs based on real-time data collected from consumer activity on the Scout Network. Examples of these are:

1) Pie charts that show how the specific market share of a particular product versus all that it competes with in its category.

2) Line charts for all active campaigns that show the number or printed RSPP for each campaign.

3) Line charts that compare past campaigns by overlaying the lines produced in Graph 2 for several products on one graph.

Scout—The Scout software system is composed of software components that manage user profiles and shopping lists, support consumers displaying and accessing RSPPs, and selecting lifegears. The software operates on a user computer system, typically a personal computer, and displays a series of interactive screens.

Consumers can use Scout to view an RSPP. If a Brand Badge exists for the RSPP, the consumer calls it up by clicking on the RSPP. The Brand Badge provides specific information associated with the product/service or the RSPP to help the consumer make a purchasing decision. The Brand Badge is designed to target consumers uniquely by using their purchase intention data, rather than consumer demographic data.

For consumers using Scout, the RSPP display with brand badge will appear only to those consumers who have made a category and brand selection that matches the brand loyalty targeting criteria established for the RSPP. These criteria are set by Distributor (see above).

Browsing through the LifeGears provided by Scout, the consumer selects product/service categories of interest and specifies brands within those categories to put on an “RSPP watch list”, such action classifying that brand as a “favorite brand”.

All categories within the LifeGear are selected by the consumer using Scout. Each family member within a household may customize his or her product choices via Lifegear selection with Scout.

### DETAILED DESCRIPTION

The following are detailed specifications of the unique features of this invention. The steps of these processes are displayed in the accompanying figures.

Scout Synchronization—In FIG. 1A and 1B, the synchronization process between the consumer software and the marketer and server software is shown. This process starts spontaneously, in the background of the consumers computer. It runs during off hours, usually at night, and coordinates the user software and data environment with that of the server computer.

New versions of the Scout software can be downloaded^{101,102,103,105}, and the most recent user parameter data, favorites, shopping lists, lifegears, and RSPP usage, are uploaded to the server^{104,106,107,108,109,110}. Proprietary server software compiles the collected consumer data and merges it with existing database information¹¹¹. The Scout software finally requests any new RSPPs matching consumer instructions^{112,113,114}.

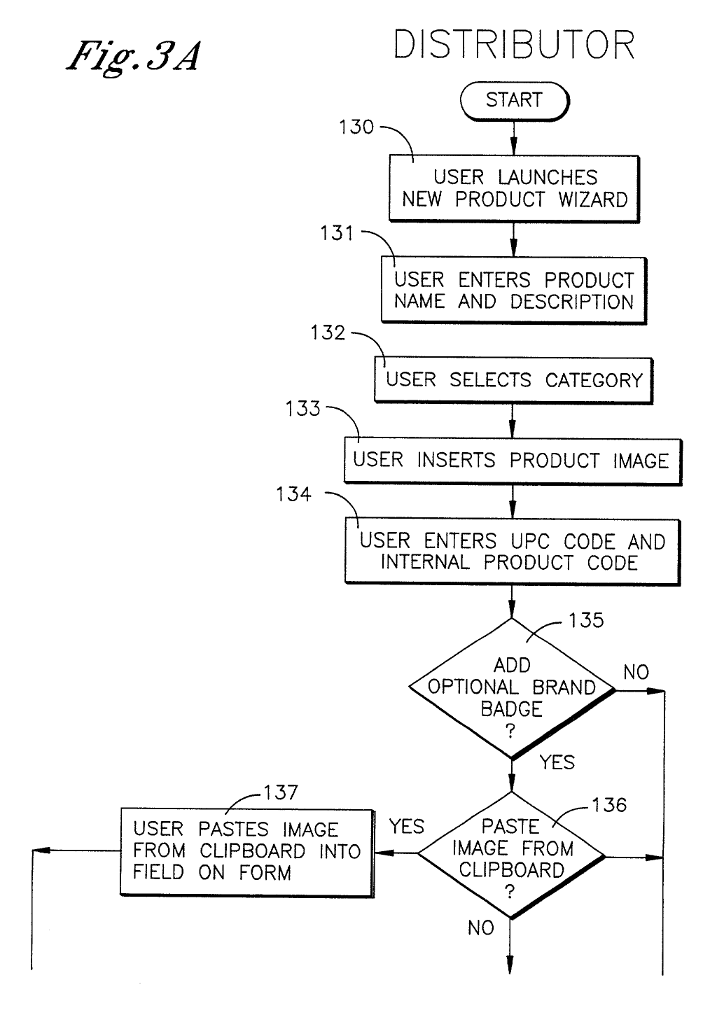

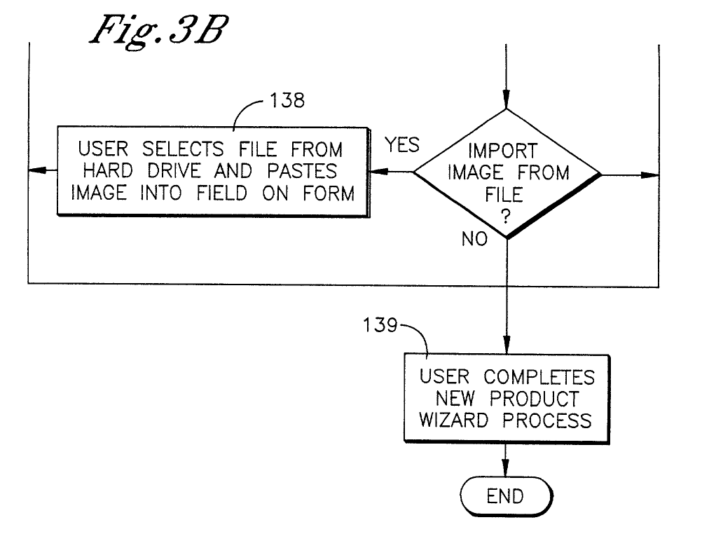

Brand Badge Process—referring to FIGS. 3A and 3B, the Brand Badge is an image that can be called up by consumers that desire more information on a product they wish to purchase or the RSPP that accompanies the product. The Brand Badge process defines how a marketer attaches this image to both the product and the RSPP. To prepare a Brand Badge for use by consumers, the marketer launches the New Product Wizard from Distributor software¹³⁰, enters the product name and description¹³¹, inserts a product image^{132,133,134} and UPC code and then inserts an image specific to the product/service or desired RSPP for the product/service^{135,136,137,138}. Distributor then stores said product or service along with its accompanying information, ready to be distributed to Scout users via the Internet¹³⁹.

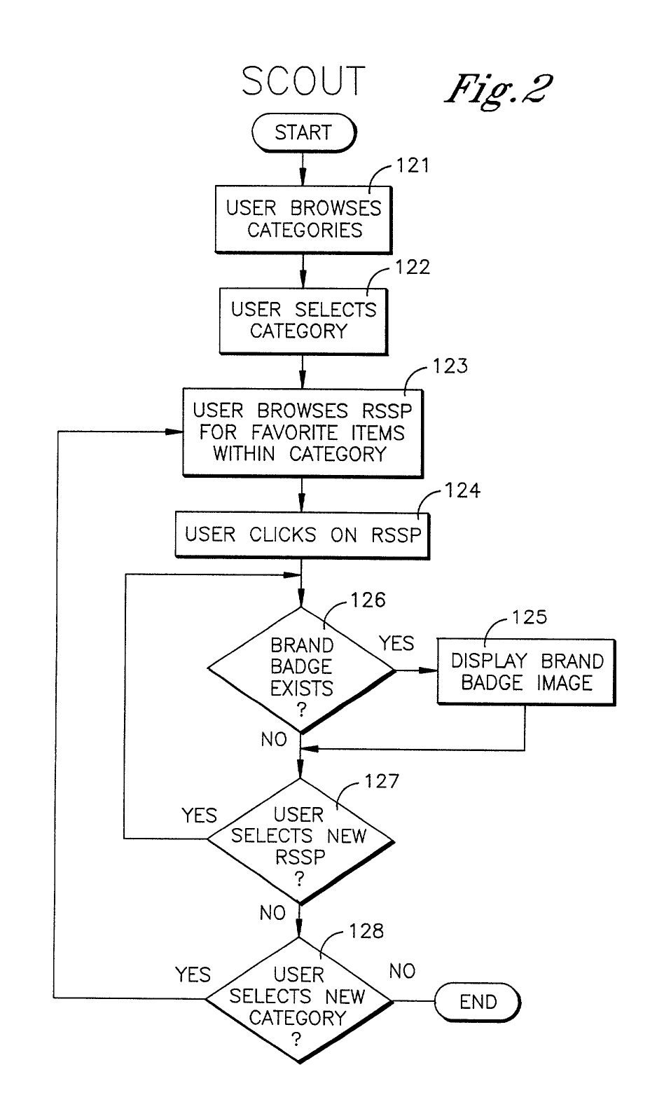

In FIG. 2, for consumers using Scout, the consumer reaches the stage where they view an RSPP^{121,122,123}. If a Brand Badge exists for that RSPP, the consumer calls it up by clicking on the RSPP^{124,125,126,127,128}. The Brand Badge provides specific information associated with the product/service or the RSPP to help the consumer make a wise purchase decision. The Brand Badge targets uniquely by using consumers purchase intention data, rather than consumer demographic data.

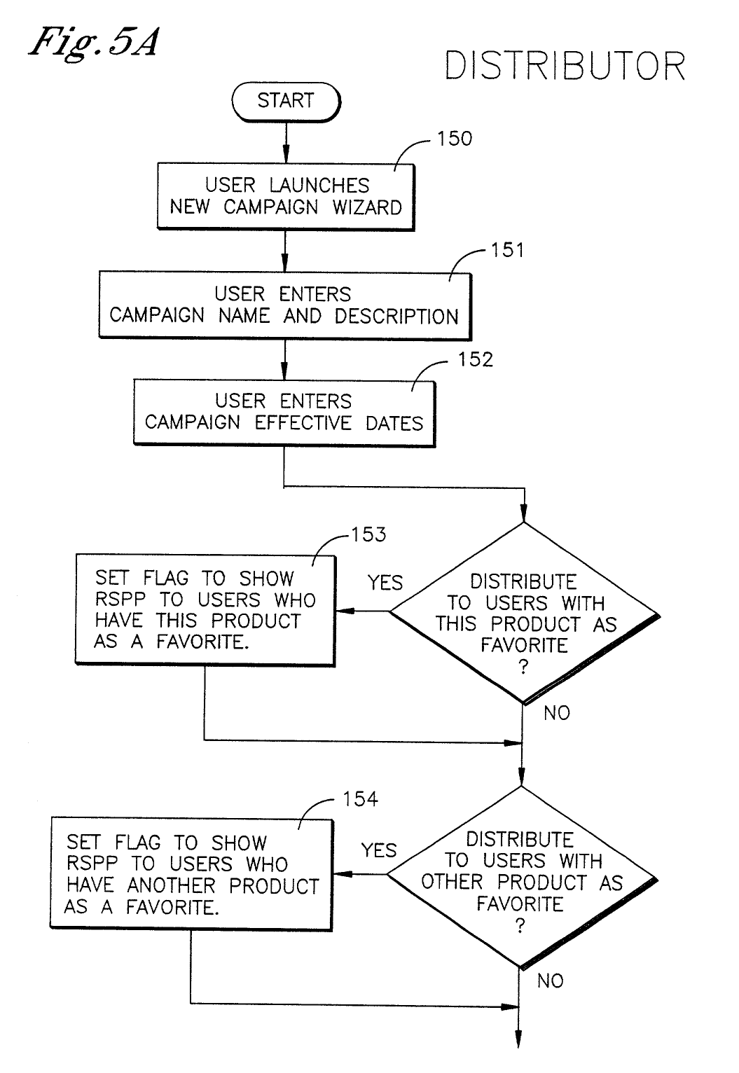

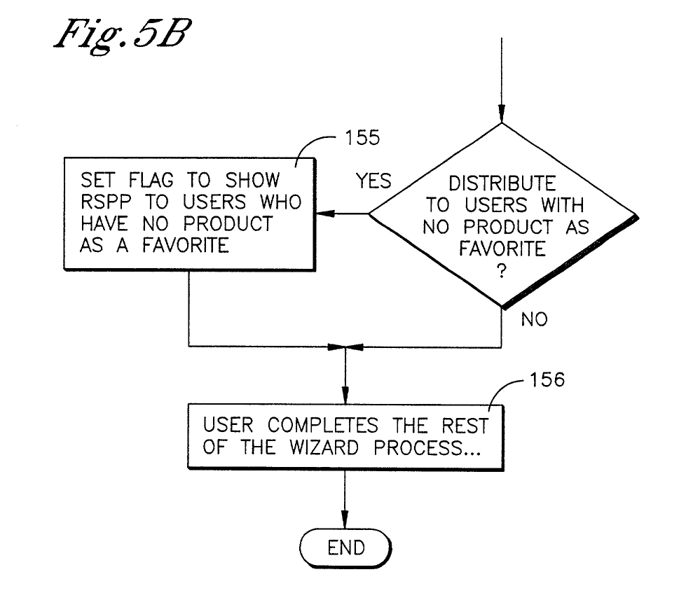

Brand Loyalty Targeting—referring to FIG. 5A and 5B, marketer's using Distributor can target consumers by their loyalty to a given product or service. RSPPs can be sent to consumer groups containing loyal or competitive users of the product. RSPP can also be sent to consumers that have not identified a preference or to all consumers in the three groups. To target an RSPP based on consumer loyalty the marketer uses Distributor to launch the New Campaign Wizard^{150,151,152}. At one point in the process the marketer decides to issue the RSPP to 1) consumers that have identified their product/service brand as a favorite (loyalty marketing)¹⁵³, or 2) consumers who have identified other product/service brands as a favorite (brand switching)¹⁵⁴, or 3) consumers that have not selected a favorite or have selected all brands as favorites¹⁵⁵. The marketer can also select two groups or all groups. The targeting decision is made by clicking a check box next to the groups to receive the RSPP.

For consumers using Scout, the RSPP will appear only to those consumers who's category and brand selection matches the brand loyalty targeting criteria established for the RSPP¹⁵⁶.

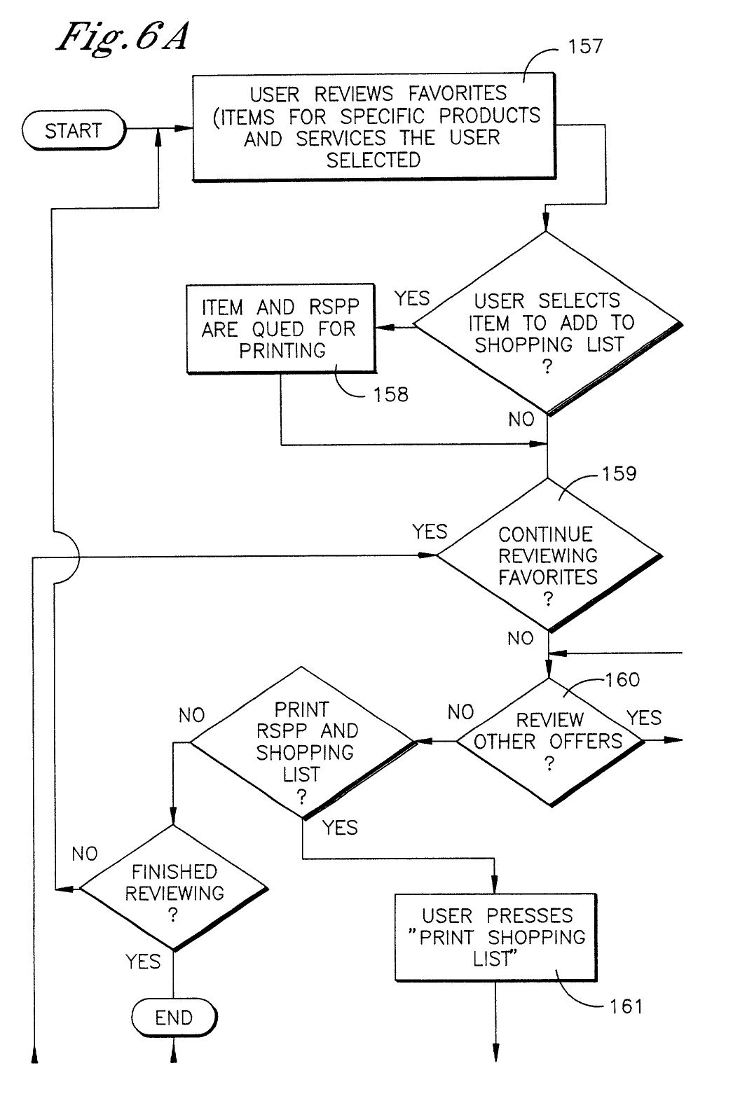

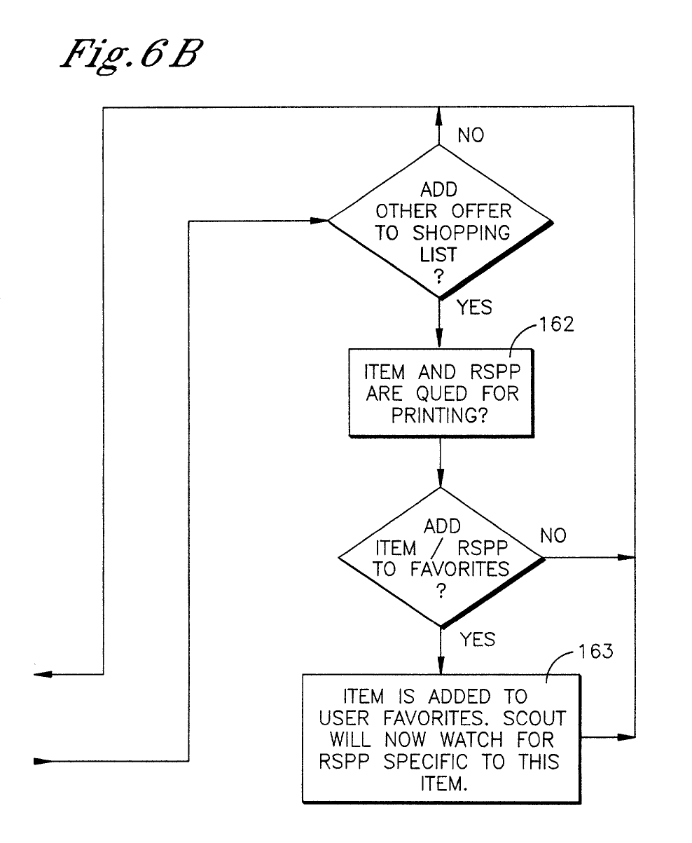

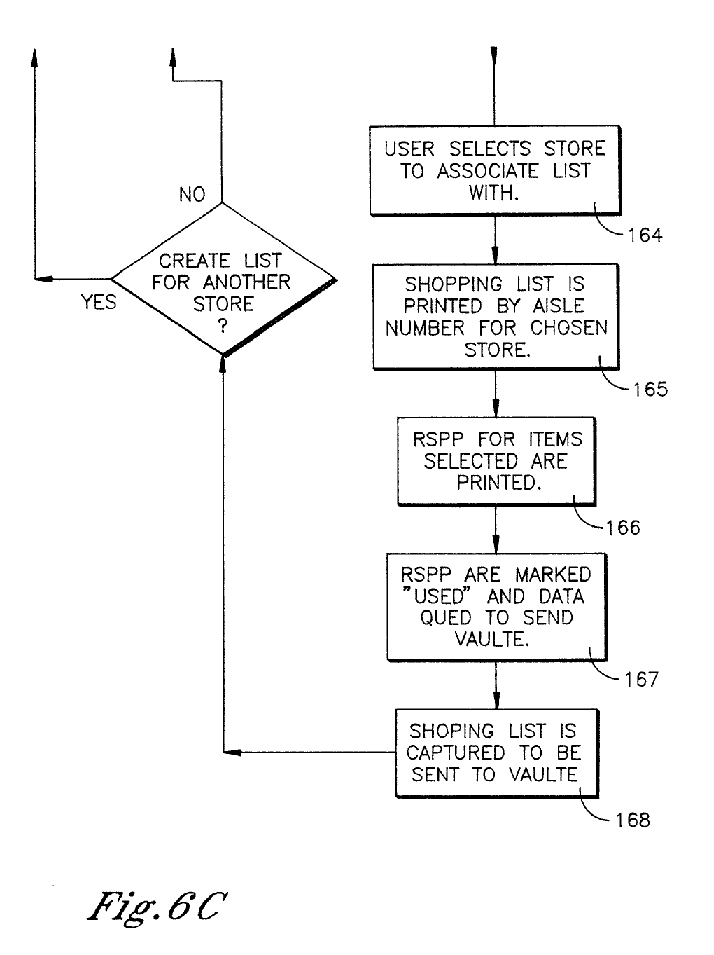

Matching RSPP to Shopping List Items—referring to FIG. 6A, 6B, and 6C, this Scout feature supports a consumer assembling a shopping list¹⁵⁷ that automatically matches associated RSPPs for any item on the list, and prints them^{158,159,160,161,162,163}. For lists generated in the Pantry (supermarket) LifeGear, the items on the list will be organized by the supermarket aisle number^{164,165,166,167}. Scout informs the network which RSPPs have been used and sends a copy of the shopping list to the server¹⁶⁸.

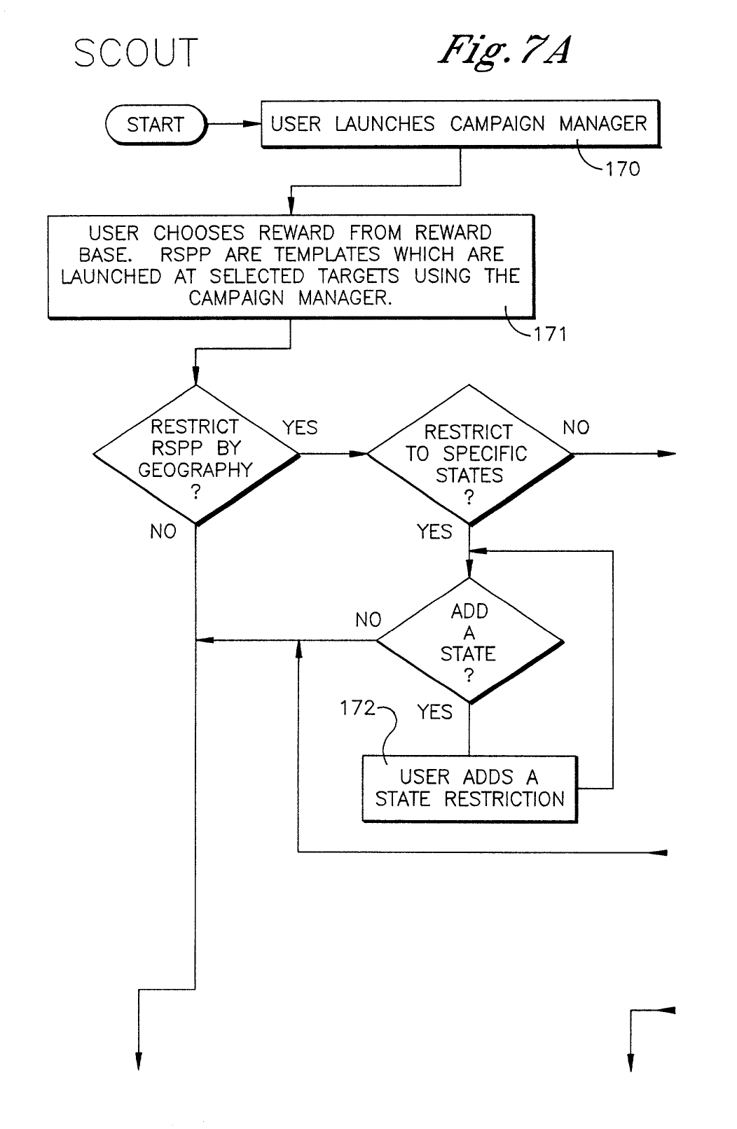

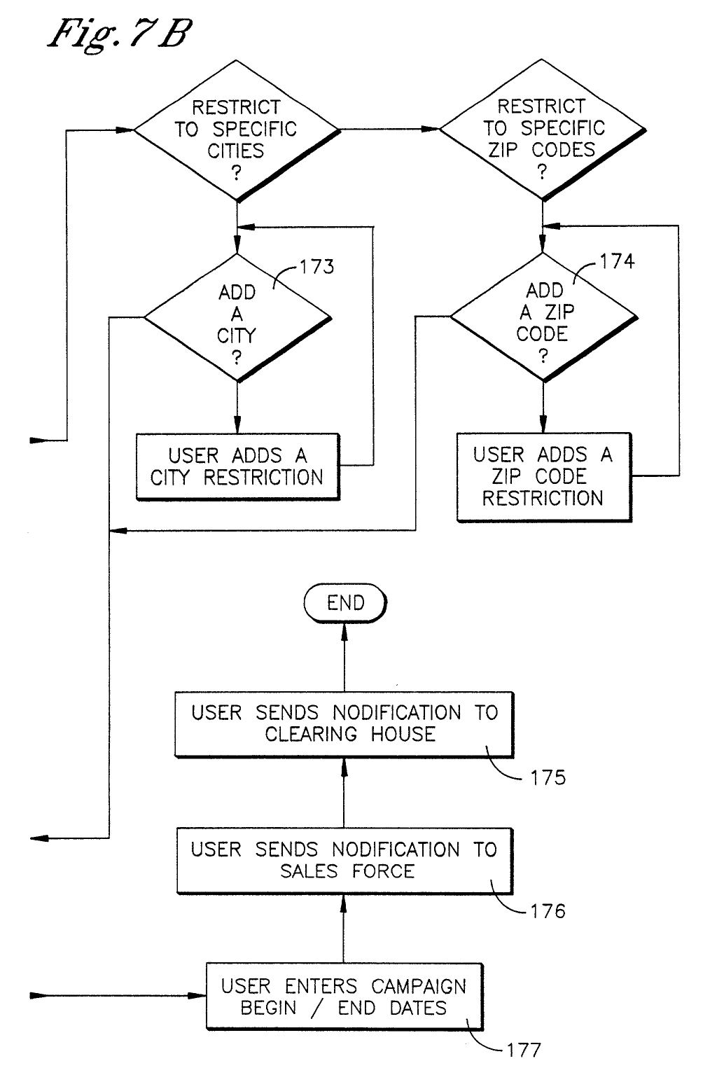

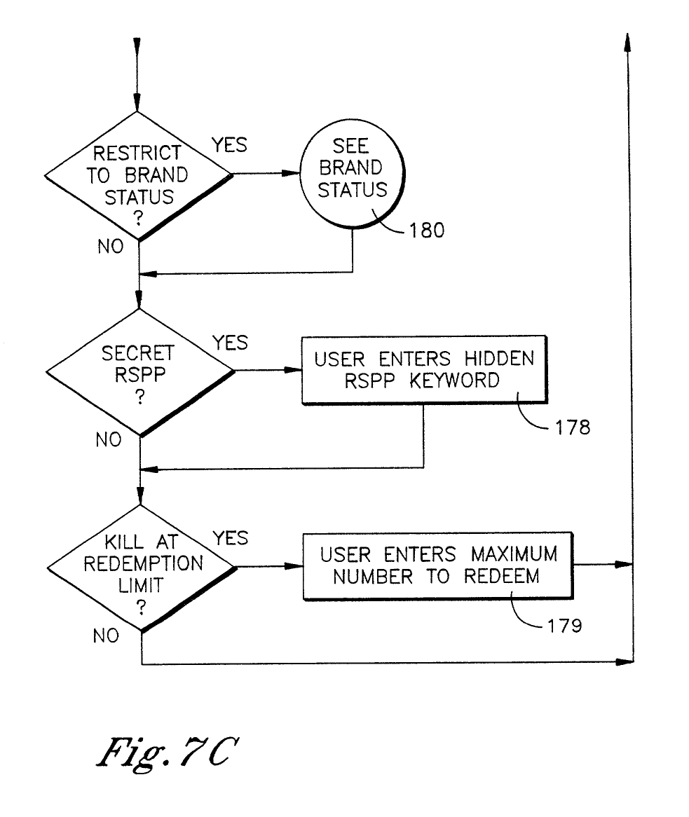

Liability Control—referring to FIGS. 7A,7B, and 7C, Distributor allows marketers to limit their RSPP by using a variety of business controls. The marketer, using Distributor^{170,171}, can restrict the RSPP to a specific geography (state, city, zip code)^{172,173,174} and/or by brand loyalty status¹⁸⁰. Additionally, marketers can define hidden rewards keywords that hide the RSPP from all Scout users except those that enter the exact keyword into Scout¹⁷⁸. The RSPP can be limited in duration¹⁷⁷ or can be limited by a “kill at number” which value defines the total allowable RSPP that can be printed across the Scout Network¹⁷⁹. Distributor users can also limit the campaign by ending it manually at anytime.

Resulting campaign limitations are forwarded to the RSPP/coupon clearing house^{175,176}.

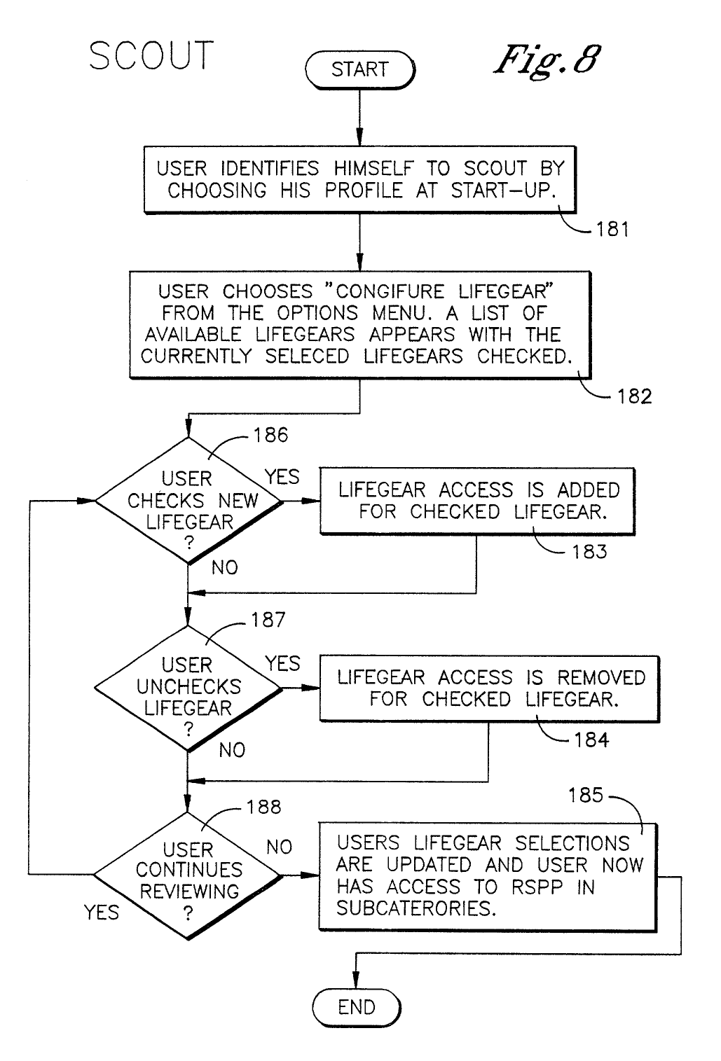

LifeGear Configuration—referring to FIG. 8, Each LifeGear contains categories of products/services that relate to that LifeGear. For example, the Pantry LifeGear contains all supermarket categories while the Restaurant LifeGear contains categories and brands of specific restaurants.

All categories within the LifeGear are selected by the specific consumer using Scout at the time¹⁸¹. Each family member may customize LifeGears and the categories within to reflect their own tastes and purchase preferences¹⁸². Browsing through the LifeGears provided by Scout, the consumer selects product/service categories of interest and specify brands within those categories to put on an “RSPP watch list”, such action classifying that brand as a “favorite brand”^{183,184,185,186,187,188}.

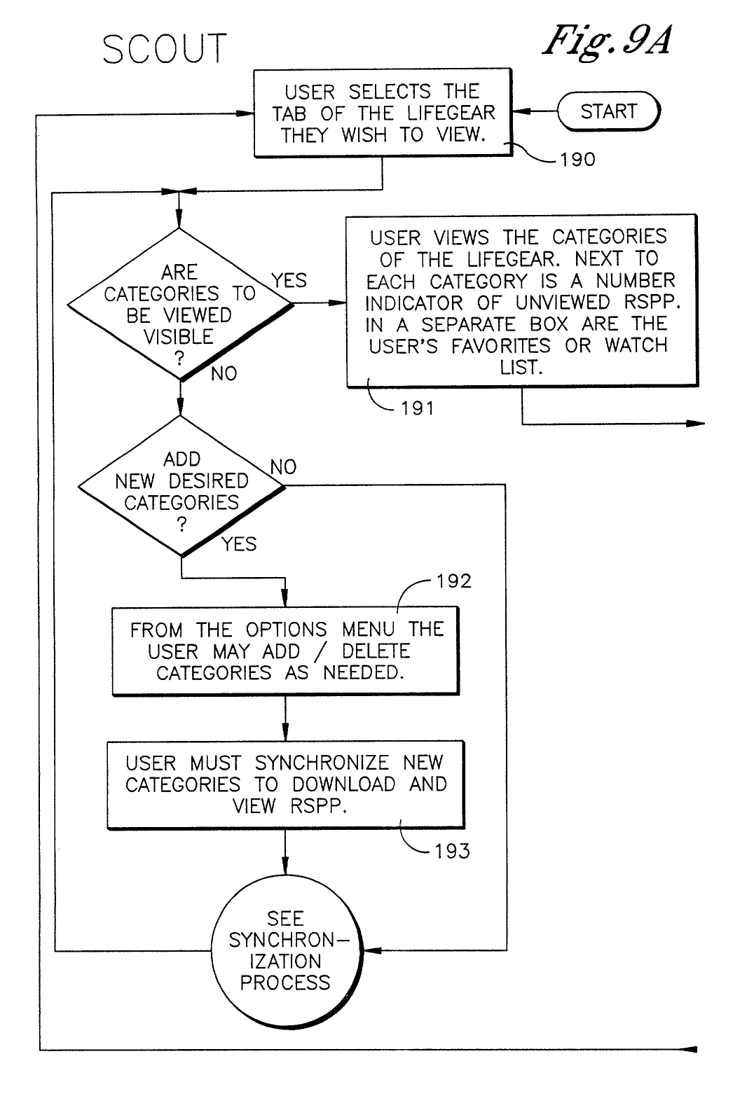

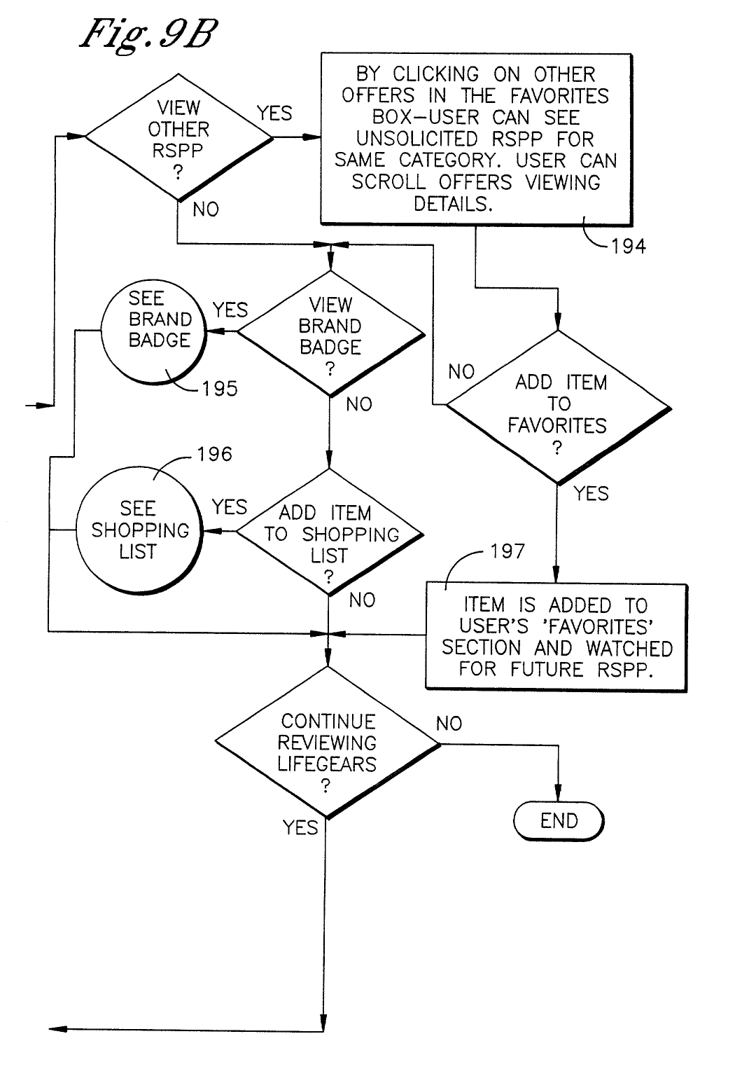

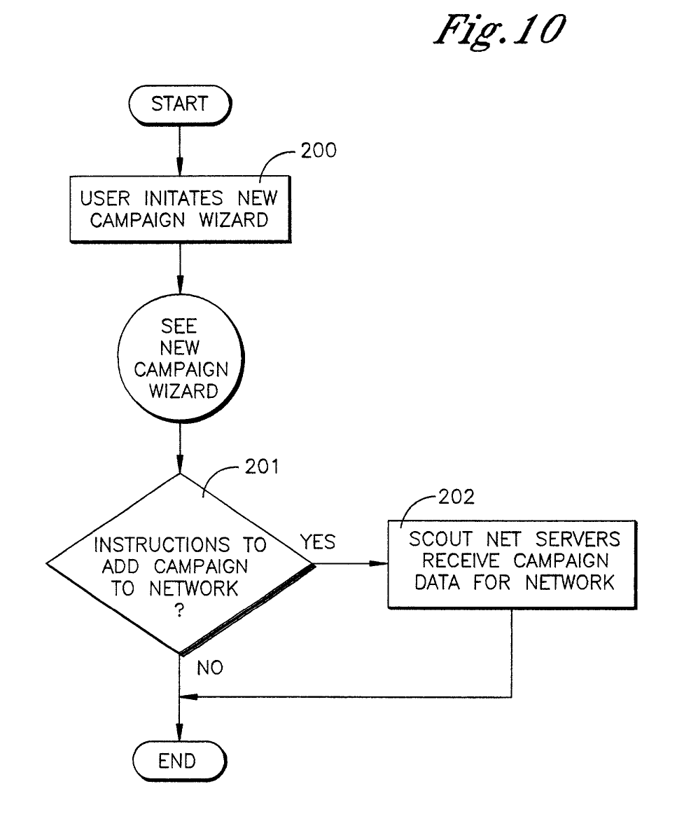

Referring to FIG. 9A and 9B, when Scout collects RSPPs for the categories, a number is presented to the right of the category name indicating the number of RSPPs collected for the category¹⁹⁰. Any RSPPs collected for the consumer's favorite brands will be displayed^{191,192,193}. The consumer may see offers for brands not indicated as a favorite by clicking a button titled “other offers”¹⁹⁴. In this way Scout screens out RSPP for unspecified categories and brands.

However, offers for a specified category but not a specified brand may be seen and redeemed by the consumer at his or her discretion. These are competitive offers and are designed to motivate the consumer to try competitive brands. From the favorites box, or the other offers box the consumer may click on the RSPP to view the brand badge and learn more about the product/service or its accompanying RSPP^{195,196,197}.

While the foregoing describes a preferred embodiment, variation on this design and equivalent designs may be resorted to in the scope and spirit of the claimed invention.

What is claimed is:

1. An internet-based, computer-driven marketing system for distributing retail/service product promotions (RSPPs) to consumers, comprising:
a secure server proprietary to the operators of said marketing system, said server in communication with a plurality of marketing computers,
said marketing computers hosting proprietary marketing software,
said proprietary marketing software comprising a database of marketing campaign wizards, campaign software to interface with marketing professionals, and means to communicate with the secure server in a confidential and secure manner,
said campaign wizards capable of designing and implementing a campaign of RSPP distribution based on demographic, individual consumer preference, and campaign duration and liability parameters,
said individual consumer preference parameters anonymous to said marketing professionals,
said server also in communication with a plurality of consumer computers, said consumer computers of a type easily available to and operable by individual consumers and present in their homes or places of business,
said consumer computers hosting proprietary consumer software,
said proprietary consumer software comprising a database of consumer preference parameters, a user interface means to interface with consumers in a forms-driven manner such that consumers may modify the contents of said database, and a consumer computer communication means.

2. The marketing system of claim 1, where the consumer computer communications means is an internet communication means, said internet communication means comprising an off-line internet communications facility and an internet communications method, selected from one of dial-up telephone, cable modem, DSL, or T1 connections.

3. The marketing system of claim 1 where said campaign wizards are directed in their operation by sequences of human-entered or pre-stored commands, product names and descriptions, product category selections, product images, universal product codes, and user defined internal product codes.

4. The marketing system of claim 3 where said product images include brand badges to be displayed to consumers.

5. The marketing system of claim 1 where said consumer preference parameters include a plurality of product preference identifications, the product preference identification including identification of the product as being an individual consumer's favorite.

6. The marketing system of claim 5 where said product preference identifications include a product category designation.

7. The marketing system of claim 5 where said product preference identifications include a product RSPP list.
